(19) United States
(12) Patent Application Publication
(10) Pub. No.: US 2004/0104928 A1
(43) Pub. Date: Jun. 3, 2004

(54) Unit management system and method

(75) Inventor: Yoshihide Morioka, Shinagawa-ku (JP)

Correspondence Address: OLIFF & BERRIDGE, PLC, P.O. BOX 19928, ALEXANDRIA, VA, 22320, US

(73) Assignee: ALLIED TELESIS K.K., Shinagawa-ku (JP)

(21) Appl. No.: 10/609,644

(22) Filed: Jul. 1, 2003

(30) Foreign Application Priority Data
Nov. 28, 2002 (WO) PCT/JP02/12450

(51) Int. Cl. G09G 5/00

(52) U.S. Cl. 345/736

(57) ABSTRACT

Each of network devices stores an SVG program for drawing GUI pictures suitable for unit management (including various settings, and acquisition of a setting and a status) of itself, and transmits it to a computer for unit management. On the part of the computer, picture drawing programs sent from the network devices are executed by use of a Web browser or the like, and the GUI pictures are displayed to a user. When the user operates on any of the GUI pictures, the computer, according to the operation, performs control for unit management on the network device having sent any of the GUI pictures which was operated upon. The network device, in accordance with the control, reads the statuses and settings of its constituent parts, and transmits the read information to the management apparatus or executes unit management such as altering a setting of the unit.

### BACKGROUND OF THE INVENTION

1. Field of the Invention

The present invention relates to an unit management system and method for management of communication nodes.

2. Description of the Prior Art

For instance, Patent References 1 and 2 disclose methods by which the Graphical User Interface (GUI) is applied to the management of communication nodes in managing network unit.

However, the methods disclosed in these Patent References require the management apparatus to make ready an operational picture for each one of the communication nodes which is subject to unit management. As the number of communication nodes becomes greater, the number of operational pictures to be made ready on the part of the management apparatus becomes greater and, accordingly, their management becomes more complex.

[Patent Reference 1] Japanese published unexamined patent application 2001-337917

[Patent Reference 2] Japanese published unexamined patent application 2001-312474

### SUMMARY OF THE INVENTION

An object of the present invention, attempted in view of the above-noted problem with the prior art, is to provide an unit management system and method which permits unit management of communication nodes, even if a large number and a great variety of them have to be managed, by use of the most suitable operational picture for each node.

Another object of the invention is to provide an unit management system and method which permits management operations of communication nodes using GUI and moreover eliminates the need on the part of the management apparatus to make ready an operational picture for each communication node which is subject to unit management.

[Unit Management System]

In order to achieve the objects stated above, an unit management system according to the invention comprises one or more communication nodes and a management apparatus connected to the communication nodes to perform unit management of each of the communication nodes, wherein each of the communication nodes has operational picture providing means for providing the management apparatus with picture data representing operational pictures for use in operations for the unit management of the communication node, and unit management means for performing the unit management of the communication node under the control of the management apparatus; and the management apparatus has operational picture display means for displaying the operational pictures by use of picture data provided by each of the communication nodes, and unit management means for controlling, in accordance with operations on the displayed operational picture, the unit management of the communication node matching the operational pictures operated upon.

[Description of the Unit Management System]

The unit management system according to the invention will be described below by way of an example.

Incidentally, the example shown below is intended to contribute to better understanding of the invention by describing it in more specific terms, and not to limit the technical scope thereof.

The unit management system according to the invention comprises one or more communication nodes such as switching hubs and routers, and a management apparatus for performing unit management of the communication nodes, the nodes and the apparatus being connected via a network such as a LAN or the Internet.

The operational picture providing means of each of the communication nodes stores, for instance, a Scalable Vector Graphics (SVG) program for drawing operational pictures suited to the unit management of that communication node (involving various settings, and acquisition of a setting and a status)

The operational picture providing means, at a request of the management apparatus side, for instance, sends the SVG program.

Sending to the management apparatus a program for drawing the pictures, instead of operational pictures themselves, can contribute to restraining the increase in traffic on the network.

On the part of the management apparatus, the operational picture display means executes the picture drawing program sent from the communication node by use of a Web browser or the like to display an operational picture to the user.

When the user operates on this operational picture, the unit management means performs, in accordance with the user's operation, control for unit management of the communication node from which the operational picture operated upon has been sent.

In accordance with this control, the unit management means on the part of the communication node executes unit management procedures, such as reading the statuses, settings and so forth of the units constituting that communication node and transmitting them to the management apparatus, or altering the setting of any unit under the control of the management apparatus.

[Communication Node]

A communication node according to the invention is controlled by a management apparatus, which displays operational pictures provided by the communication node and performs control for unit management in accordance with operations on the displayed operational pictures. The communication node has: an operational picture providing means for providing the management apparatus with picture data representing the operational pictures for use in operations for the unit management, and unit management means for performing the unit management under the control of the management apparatus.

Preferably, the communication node should have one or more ports for communication, and the operational picture providing means should provide the management apparatus with picture data representing operational pictures including one or more port pictures respectively representing the one or more ports.

Preferably, the operational picture providing means should provide the management apparatus with, as the picture data, a picture drawing program for displaying the operational pictures.

[Management Apparatus]

A management apparatus according to the invention is connected to one or more communication nodes to perform unit management of each of the communication nodes, wherein each of the communication nodes provides the management apparatus with picture data representing operational pictures for use in operations for the unit management of the communication node, and performs the unit management of the communication node under the control of the management apparatus, operational picture display means for displaying the operational picture by use of picture data provided by each of the communication nodes, and unit management means for controlling, in accordance with operations on the displayed operational pictures, the unit management of the communication node matching the operational pictures operated upon.

Preferably, each of the communication nodes should provide, as the picture data, a picture drawing program for displaying the operational pictures, and the operational picture display means should execute the picture drawing program provided by each of the communication nodes to display the operational pictures.

Preferably, each of the communication nodes should, in response to control by the management apparatus, return unit information indicating a status and a setting or either of them of the communication node to the management apparatus, and the operational picture display means should alter contents of the displayed operational pictures on the basis of the unit information from the communication node.

Preferably, each of the communication nodes should have one or more ports for communication and provide the management apparatus with picture data representing operational pictures including one or more port pictures respectively representing the one or more ports, the operational picture display means should display operational pictures including the one or more port pictures by use of picture data provided by each of the communication nodes, and the unit management means, in accordance with operations on the one or more port pictures included in the displayed operational pictures, should control the communication node matching the operational pictures operated upon to perform unit management of the ports respectively matching the port pictures operated upon.

Preferably, the operational picture display means should, in response to operations on each of the one or more port pictures, alter the display of each of the port pictures having undergone the operation.

[First Unit Management Method]

A first unit management method according to the invention is an unit management method for communication nodes managed by a management apparatus, wherein the management apparatus displays operational pictures provided by the communication nodes, performs control for unit management in accordance with operations on the displayed operational pictures, provides the management apparatus with picture data representing operational pictures for use in operations for the unit management, and performs the unit management in accordance with control by the management apparatus.

[Second Unit Management Method]

A second unit management method according to the invention is an unit management method to be performed by a management apparatus, connected to one or more communication nodes, for performing unit management of each of the communication nodes, wherein each of the communication nodes provides the management apparatus with picture data representing operational pictures for use in operations for the unit management of the communication node, performs the unit management of the communication node in accordance with control by the management apparatus, displays the operational pictures by use of picture data provided by each of the communication nodes, and performs, in accordance with operations on the displayed operational pictures, the unit management of the communication node matching the operational pictures operated upon.

[First Program]

A first program according to the invention is a program to be executed by communication nodes each including a computer and managed by a management apparatus, wherein the management apparatus displays operational pictures provided by the communication nodes and performs control for unit management in accordance with operations on the displayed operational pictures, the program causing the computer to execute: a step of providing the management apparatus with picture data representing operational pictures for use in operations for the unit management, and a step of performing the unit management in accordance with control by the management apparatus.

[Second Program]

A second program according to the invention is a program to be executed by a management apparatus, including a computer and connected to one or more communication nodes, to perform unit management of each of the communication nodes, wherein each of the communication nodes provides the management apparatus with picture data representing operational pictures for use in operations in the unit management of the communication node and, in accordance with control by the management apparatus, performs the unit management of the communication node, the program causing the computer to execute: a step of displaying the operational pictures by use of picture data provided by each of the communication nodes, and a step of performing control for the unit management, in accordance with operations on the displayed operational pictures, of the communication node matching the operational pictures operated upon.

### BRIEF DESCRIPTION OF THE DRAWINGS

FIG. 1 shows an example of configuration of a network system to which an unit management method according to the present invention is adaptable;

FIG. 2 shows an example of configuration of a network device shown in FIG. 1;

FIG. 3 shows an example of configuration of a computer for network management shown in FIG. 1;

FIG. 4 shows an example of configuration of a network device program operating on the network device shown in FIG. 1 and FIG. 2;

FIG. 5 shows an example of a template of operational pictures to be stored in the operational picture memory section shown in FIG. 4;

FIG. 6 shows an example of an SVG program for drawing the template of operational pictures shown in FIG. 5;

FIG. 7 is a flowchart showing the operation of the network device program (S10) shown in FIG. 4;

FIG. 8 shows an example of configuration of the network management program to be executed on the computer shown in FIG. 1 and FIG. 3;

FIG. 9 is a second diagram showing an example of a first GUI picture prepared by the Web browser shown in FIG. 8;

FIG. 10 is a second diagram showing an example of a first GUI picture prepared by the Web browser shown in FIG. 8;

FIG. 11 is a first flowchart of processing (S12) regarding the template (FIG. 5) of the network management program shown in FIG. 8;

FIG. 12 is a flowchart of other processing (S14) regarding other than the template (FIG. 5) of the network management program shown in FIG. 8;

FIG. 13 shows an example of a second GUI picture which the GUI control section shown in FIG. 8 first displays;

FIG. 14 shows an example of a third GUI picture which the GUI control section shown in FIG. 13 displays in response to the operations on the second GUI picture shown in FIG. 13;

FIG. 15 is a first diagram showing an example of variation of the third GUI picture shown in FIG. 14;

FIG. 16 is a second diagram showing an example of variation of the third GUI picture shown in FIG. 14;

FIG. 17 is a third diagram showing an example of variation of the third GUI picture shown in FIG. 14;

FIG. 18 is a sequence diagram showing a request for a template and the operation to transmit it (S20) in a network system;

FIG. 19 is a sequence diagram showing a request for unit information and the operation to transmit it (S22) in the network system; and

FIG. 20 is a sequence diagram showing a request for a setting change and a response thereto (S24) in the network system.

### DESCRIPTION OF THE PREFERRED EMBODIMENTS

The preferred embodiments of the present invention will be described in detail below.

[Network System 1]

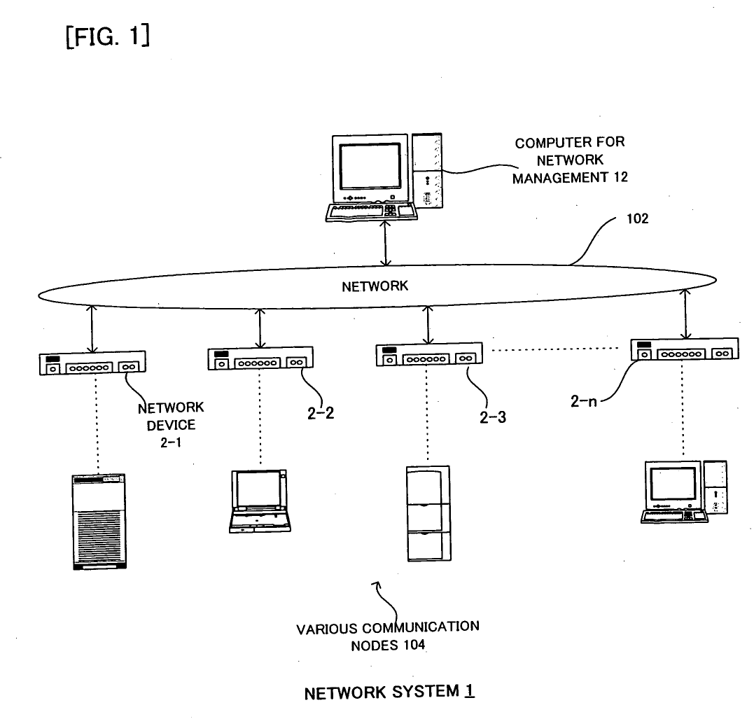

FIG. 1 shows an example of configuration of a network system 1 to which an unit management method according to the invention is adaptable.

As shown in FIG. 1, the network system 1 has a configuration in which one or more network devices 2-1 through 2-n (n ? 1) such as a router, switching hub or the like are connected to a computer 12 for network management via a network 102 such as a LAN.

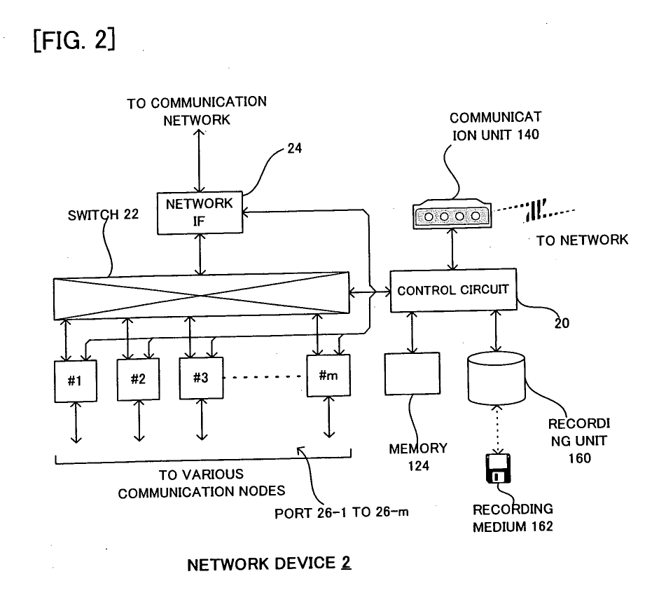

Each of the network devices 2-1 through 2-n has one or more communication ports 26-1 through 26-m (m ? 1; to be elaborated upon afterwards with reference to FIG. 2), and to each of these ports is connected one or another of various communication nodes 104 such as a computer, server or the like. The communication nodes 104 perform data communication with the network 102.

In the following description, an unspecified item of any constituent parts which may be provided in plurality, such as the network devices 2-1 through 2-m, may be referred to simply as a (the) network device 2 or the like.

[Hardware]

Next will be described hardware items of the network device 2 and the computer 12 shown in FIG. 1.

[Network Devices 2]

FIG. 2 illustrates an example of configuration of one of the network devices 2 shown in FIG. 1.

As shown in FIG. 2, the network device 2 is configured of a control circuit 20 comprising a CPU and peripheral circuits thereto, a memory 124, a recording unit 160, a communication unit 140 for performing communication with the computer 12, a switch 22, a network interface (network IF) 24, and the ports 26-1 through 26-m.

In other words, the network device 2 may be, for instance, a switching hub unit, and comprises the usual constituent parts of a switching hub.

[Computer 12]

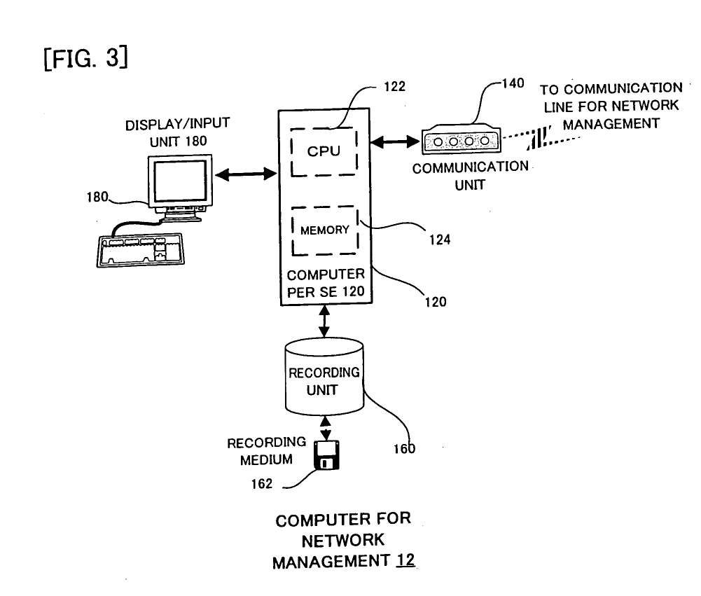

FIG. 3 illustrates the configuration of the computer 12 for network management shown in FIG. 1.

As shown in FIG. 3, the computer 12 is composed of a computer per se 120 comprising a CPU 122, the memory 124 and circuits peripheral thereto, the communication unit 140 for performing communication with the network devices 2, the recording unit 160 which may be a CD unit on an HDD, and a display/input unit 180 comprising a display unit, keyboard, mouse and the like.

Thus, the computer 12 contains the constituent parts of a usual computer which permits communication with the network devices 2.

[Software]

Next will be described software items to operate on the network devices 2 and the computer 12 shown in FIG. 1.

[Network device Program 3]

First will be described a network device program 3 to operate on the network devices 2.

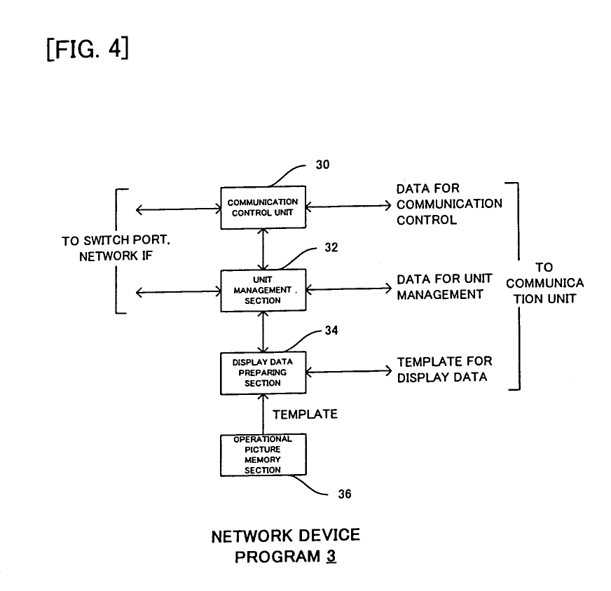

FIG. 4 illustrates the configuration of the network device program 3 to operate on the network devices 2 shown in FIG. 1 and FIG. 2.

As shown in FIG. 4, the network device program 3 is composed of a communication control section 30, an unit management section 32, a display data preparing section 34 and an operational picture memory section 36.

The network device program 3 is supplied from, for instance, a recording medium 162 to a network device 2 (FIG. 1 and FIG. 2), loaded onto the memory 124 for execution to carry out such functions as communication control, unit management, template supply and preparation of data to be displayed.

The communication control section 30 transmits and receives data for communication control to and from the computer 12 (FIG. 1 and FIG. 3) as required via the communication unit 140 (FIG. 2), and controls the switch 22, the network IF 24 and ports 26 to perform the necessary control for communication between the network 102 and the communication nodes 104 or mutual communication between the communication nodes 104.

The unit management section 32, which is, for instance, a Simple Network Management Protocol (SNMP) agent, receives a request from the computer 12 via the communication unit 140 in accordance with SNMP and, in response to this request, performs setting of the switch 22, the network IF 24 and ports 26.

Also, the unit management section 32, similarly in response to a request from the computer 12, prepares unit status information indicating the statuses of the switch 22, the network IF 24, and ports 26, and transmits it to the computer 12 via the communication unit 140.

Incidentally, to be elaborated upon afterwards, the unit status information prepared by the unit management section 32 is transmitted, as required, to the computer 12 via a display data preparing section 34.

[Operational Picture Memory Section 36 and Display Data Preparing Section 34]

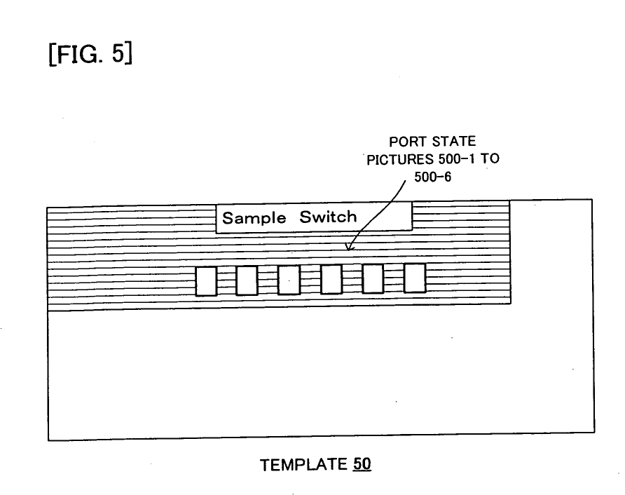

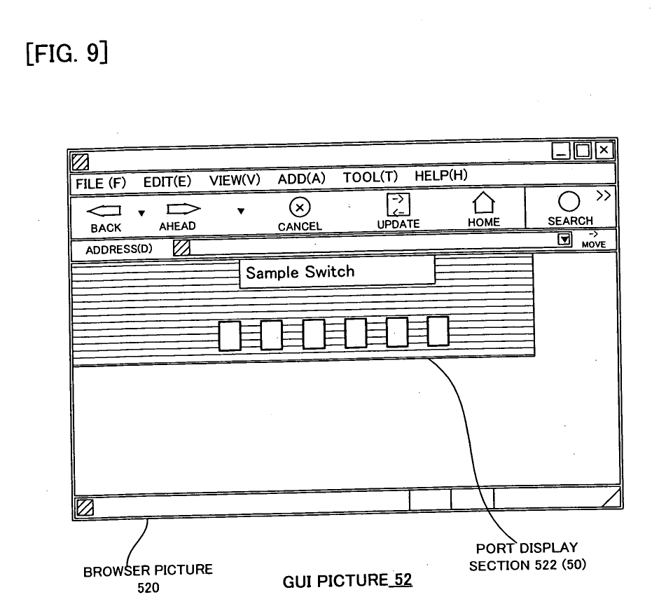

FIG. 5 shows an example of a template 50 of operational pictures (Graphical User Interface (GUI) pictures) to be stored in the operational picture memory section 36 shown in FIG. 4 (to be further described afterwards with reference to FIG. 9 and others).

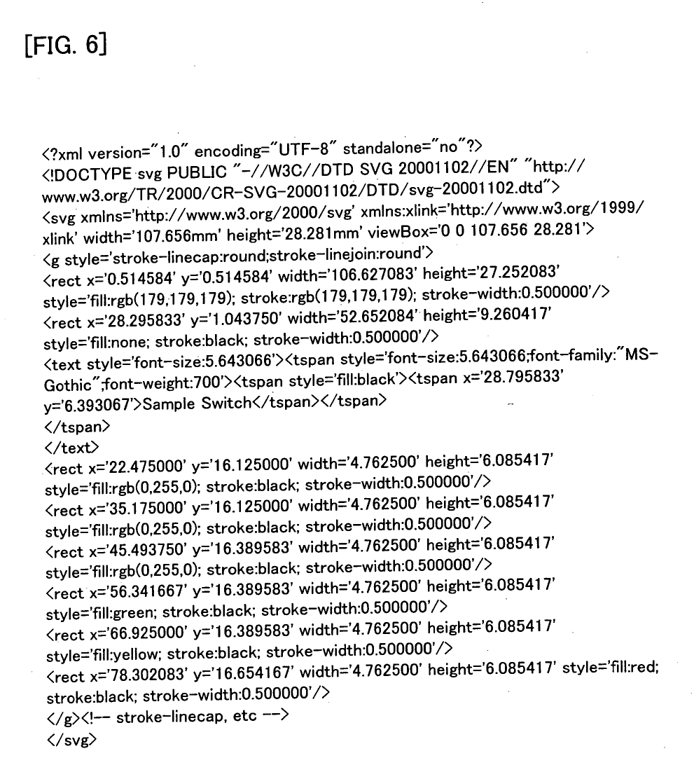

FIG. 6 shows an example of an SVG program for drawing the template 50 of operational pictures shown in. FIG. 5.

The operational picture memory section 36 (FIG. 4) stores the template 50 of operational pictures (GUI pictures) to be used by the computer 12 for unit management of such network devices 2 as are shown in FIG. 5, and provides it to the display data preparing section 34.

Additionally, the operational picture memory section 36 stores the template 50 of operational pictures (GUI pictures) shown in FIG. 5 not in a form involving a large quantity of data, such as a bit map but as a Scalable Vector Graphics (SVG) program involving a smaller quantity of data for drawing, for instance, the operational pictures (GUI pictures) to be executed on the part of the computer 12 as shown in FIG. 6, in order thus to prevent the traffic through the network 102 from increasing.

The display data preparing section 34 (FIG. 4) transmits, in response, for instance, to a request received from the computer 12 via the unit management section 32, the template 50 stored in the operational picture memory section 36 to the computer 12 via the communication unit 140.

For this transfer of the template 50 between a network device 2 and the computer 12, HyperText Transfer Protocol (HTTP), for instance, or Hyper Text Transfer Protocol Security (HTTPS) combining HTTP with Secure Socket Layer (SSL) are used. The latter is particularly suitable for use in transferring such data because SSL serves to maintain security.

Alternatively, when an operational picture (GUI picture) using the template 50 is displayed in the computer 12, the display data preparing section 34 converts unit status information and the like prepared by the unit management section 32 into a mode fitting the displays in this operational picture (GUI picture), and transmits the converted information to the computer 12 as display data.

[Operation of Network device Program 3]

Now will be described the overall operation of the network device program 3.

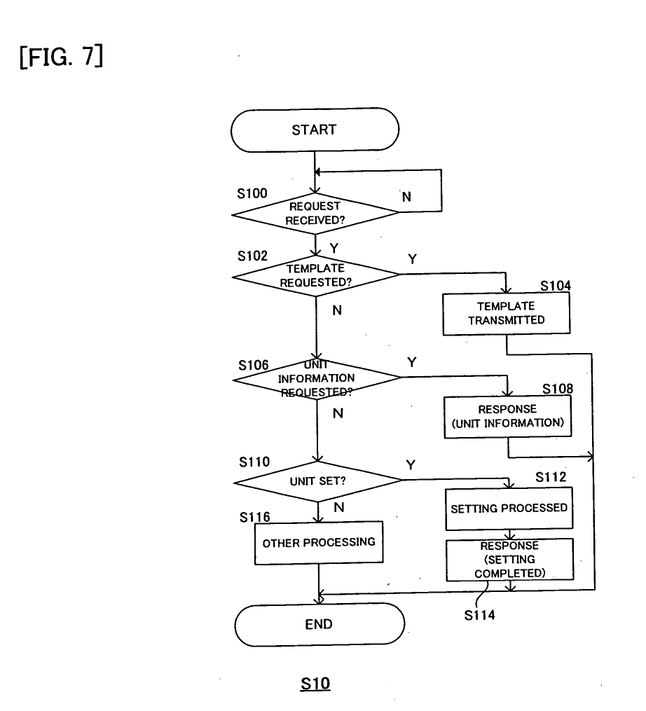

FIG. 7 is a flowchart showing the operation of the network device program 3 (S10) shown in FIG. 4.

As shown in FIG. 7, at step 100 (S100), the unit management section 32 (FIG. 4) of the network device program 3 operating on a network device 2 (FIG. 1 and FIG. 2) determines whether or not any request concerning unit control has been received from the computer 12.

If any request has been received, the network device program 3 goes ahead to processing of S102, or otherwise stays with processing of S100.

At step 102 (S102), the unit management section 32 determines whether or not the received request is for the template 50 (FIG. 5).

If the received request is for the template 50, the unit management section 32 goes ahead to processing of S104, or otherwise goes ahead to processing of S106.

At step 104 (S104), the unit management section 32 gives a request for the template to the display data preparing section 34, and the display data preparing section 34, in response to this request, transmits the template 50 to the computer 12.

At step 106 (S106), the unit management section 32 determines whether or not the received request is for unit information.

If the received request is for unit information, the unit management section 32 goes ahead to processing of S110, or otherwise goes ahead to processing of S108.

At step 108 (S108), the unit management section 32 acquires, for instance, the status and setting of each of the ports 26-1 through 26-m (FIG. 2) (for instance, if OperStatus and if AdminStatus of the Management Information Base (MIB) defined in RFC1213).

Further, if any operation using the template 50 (FIG. 5) is being done by the computer 12 (FIG. 1 and FIG. 3), the unit management section 32 supplies the display data preparing section 34 with unit information indicating such statuses and settings.

The display data preparing section 34 converts this unit information into display data fitting operational pictures (GUI pictures) in the computer 12, and in response transmits the converted data to the computer 12.

At step 110 (S110), the unit management section 32 determines whether or not the received request is for the setting (for instance, a change in the if AdminStatus mentioned above) of the unit.

If the request is for the setting of the unit, the network device program 3 goes ahead to processing of S112, or otherwise goes ahead to processing of S116.

At step 112 (S112), the unit management section 32 in compliance with the received request, sets a network device 2 (FIG. 1 and FIG. 2).

Upon completion of the setting of the network device 2, the unit management section 32 at step 114 (S114) responds by transmitting a notice of the completion of the setting to the computer 12.

At step 116 (S116), the network device program 3 meets other processing requirements. [Network Management Program 4]

Next will be described a network management program 4 to operate on the computer 12.

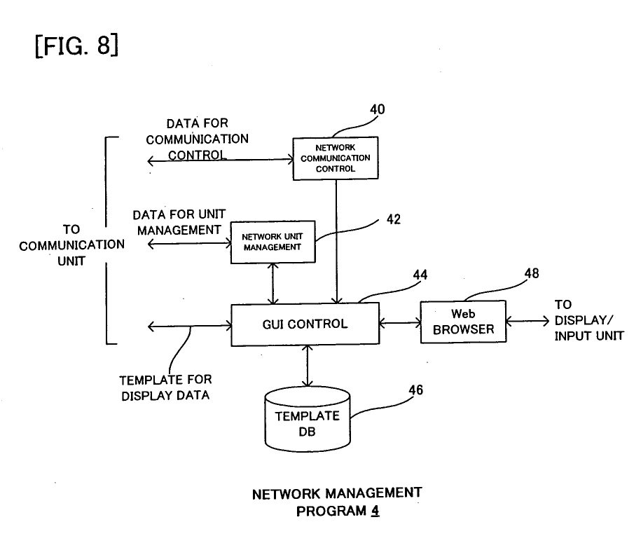

FIG. 8 shows an example of configuration of the network management program 4 to be executed on the computer 12 shown in FIG. 1 and FIG. 3.

As shown in FIG. 8, the network management program 4 comprises a network communication control section 40, a network unit management section 42, a GUI control section 44, a template database (template DB) 46 and a Web browser 48.

The network management program 4 is supplied to the computer 12 from, for instance, the recording medium 162 (FIG. 3), loaded onto the memory 124 and executed.

The network management program 4 performs with these constituent parts such functions as communication control, unit management of the network devices 2, storage of the template 50 of operational pictures (GUI pictures) (FIG. 5) and provision of a GUI environment as shown below.

The network communication control section 40, in response to an operation by the user of the network management program 4, transmits and receives data for communication control between the network devices 2-1 through 2-n (FIG. 1 and FIG. 2) as required, and thereby controls the network devices 2-1 through 2-n for communication processing by each.

The network unit management section 42, in response to an operation by the user of the computer 12 entered via the GUI control section 44 or according to a predetermined schedule, transmits and receives data for unit management between the network devices 2-1 through 2-n, and manages each of the network devices 2-1 through 2-n for unit management based on, for instance, SNMP.

[Web Browser 48 and GUI Control Section 44]

FIG. 9 is a second diagram showing an example of a first GUI picture 52 prepared by the Web browser 48 shown in FIG. 8.

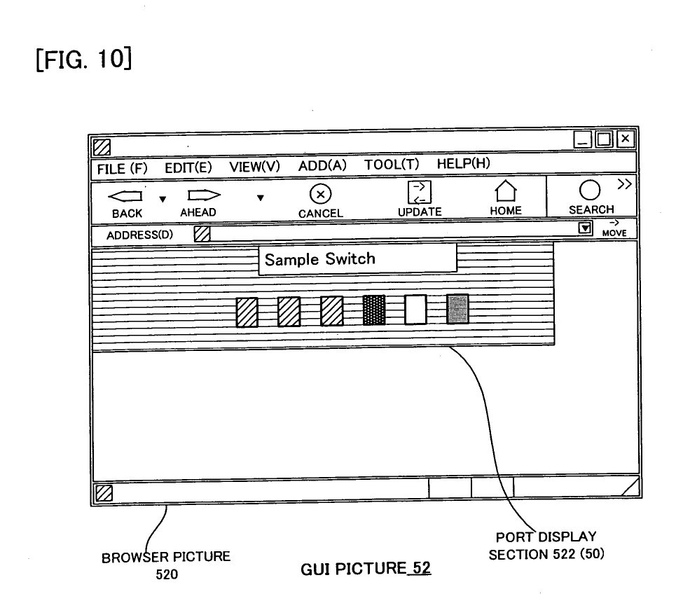

FIG. 10 is a second diagram showing an example of a first GUI picture 52 prepared by the Web browser 48 shown in FIG. 8.

The Web browser 48 can be the Internet Explorer (trademark of Microsoft Corporation), Netscape Navigator (trademark of Netscape Communications) or some other browser. It executes the SVG program (FIG. 6) for drawing the template 50 and, as shown in FIG. 9, displays it in a browser picture 520 as an operational picture (GUI picture; a port display section 522 in FIG. 9).

Also, the Web browser 48 accepts an operation by the computer 12 upon the first GUI picture 52 and supplies it to the GUI control section 44.

When, for instance, the network system 1 (FIG. 1) is actuated for the first time or a new network device 2 is connected to the network system 1, the GUI control section 44 (FIG. 8) requests via the network unit management section 42 each of the network devices 2-1 through 2-n or the newly connected network device 2, as the case may be, to transmit the template 50 (FIG. 5), and causes the template DB 46 to store the template 50 sent from the network devices 2 in response to this request.

Also, the GUI control section 44, in response to an operation by the user of the computer 12, supplies the template 50 to every one of the network devices 2-1 through 2-n stored in the template DB 46 to the Web browser 48, and causes it to be displayed as shown, by way of example, in FIG. 9.

Further, the GUI control section 44 accepts via the Web browser 48 an operation by the user of the computer 12, and supplies it to the network unit management section 42.

Additionally, as shown in FIG. 10, if any button in the port display section 522 is clicked in the first GUI picture 52, that click can be displayed by altering the color, brightness or shape of the button.

[Operation of Network Management Program 4]

Now will be described the overall operation of the network management program 4.

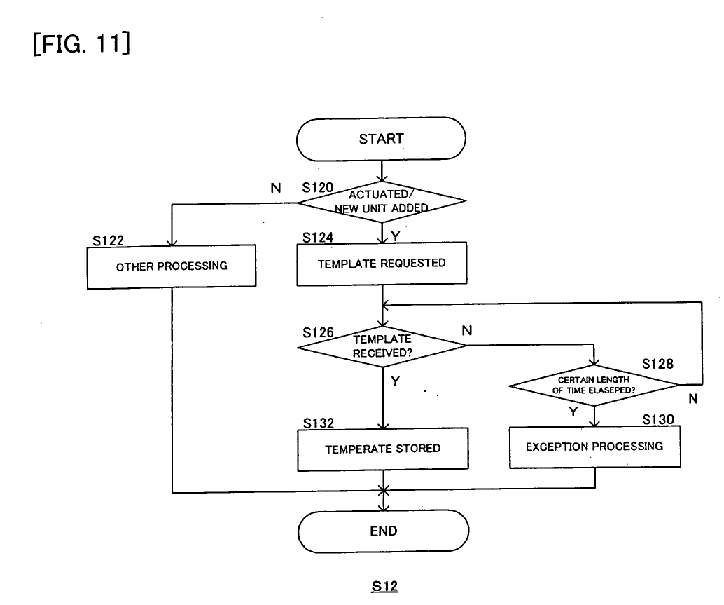

FIG. 11 is a first flowchart of processing (S12) regarding the template 50 (FIG. 5) of the network management program 4 shown in FIG. 8.

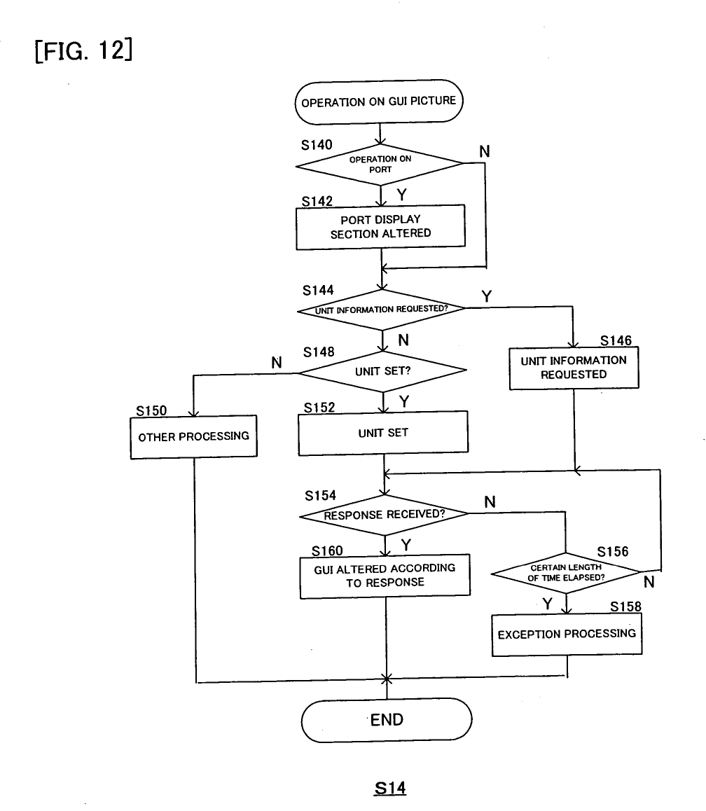

FIG. 12 is a flowchart of processing (S14) other than in respect of the template (FIG. 5) of the network management program 4 shown in FIG. 8

As shown in FIG. 11, at step 120 (S120), the GUI control section 44 determines whether the network system 1 (FIG. 1) has been actuated for the first time, or whether a new network device 2 has been added to the network system 1.

If the network system 1 (FIG. 1) has been actuated for the first time or a new network device 2 has been added to the network system 1, the network management program 4 goes ahead to processing of S124, or otherwise goes ahead to processing of S122.

At step 122 (S122), the network management program 4 goes ahead to other processing than that in respect of the template 50 (S14; FIG. 12).

At step 124 (S124), if the network system 1 (FIG. 1) has been actuated for the first time, the GUI control section 44 issues a request for transmission of the template 50 to every one of the network devices 2-1 through 2-n, or if a new network device 2 has been added to the network system 1, to the added network device 2.

At step 126 (S126), the GUI control section 44 determines whether or not the template 50 from any network device 2 (FIG. 1 and FIG. 2) has been received.

If the template 50 has been received, the network management program 4 goes ahead to processing of S132, or otherwise goes ahead to processing of S128.

At step 128 (S128), the GUI control section 44 determines whether or not a certain length of time has passed since it requested the network devices 2 to transmit the template 50.

If that length of time has passed, the network management program 4 goes ahead to processing of S130 or otherwise returns to processing of S126.

At step 130 (S130), the GUI control section 44 performs exception processing such as displaying an error message on the display/input unit 180 (FIG. 3) of the computer 12, via the Web browser 48.

At step 132 (S132), the GUI control section 44 stores the received template 50 (FIG. 5) into the template DB 46.

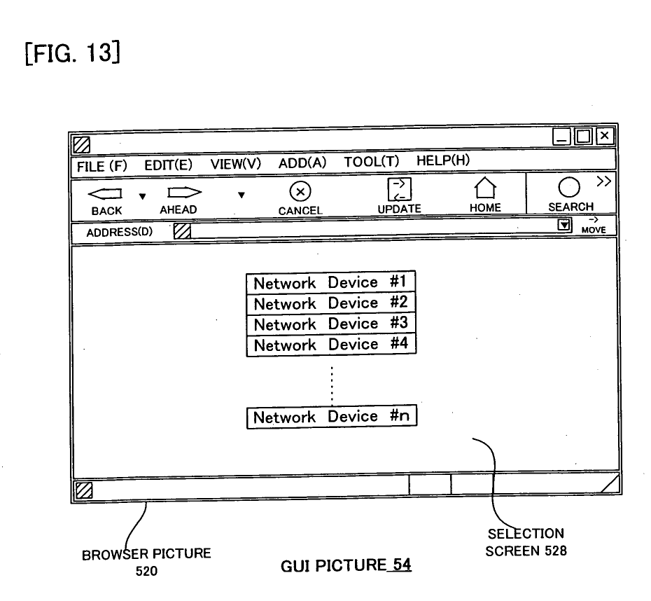

FIG. 13 shows an example of a second GUI picture 54 which the GUI control section 44 shown in FIG. 8 first displays.

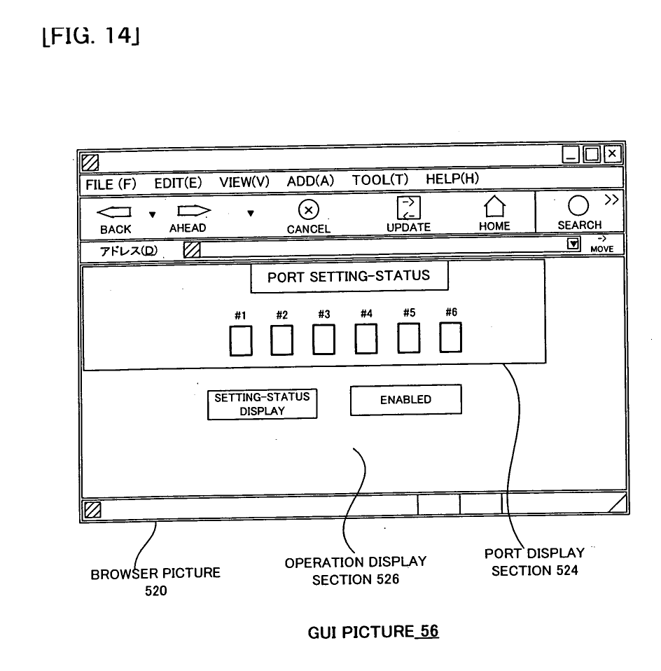

FIG. 14 shows an example of a third GUI picture 44 which the third GUI control section 56 shown in FIG. 13 displays in response to the operation on the second GUI picture shown in FIG. 13.

When the network management program 4 goes to processing of S14 shown in FIG. 12, the GUI control section 44 causes the Web browser 48 to display in the browser picture 520 the second GUI picture 54 containing a selection screen 528 to urge selection of one of the network devices 2-1 through 2-n as shown in FIG. 13.

As the user makes an operation to choose one of the icons (Network device #1, . . . , #n) displayed on the second GUI picture 54 and respectively representing the network devices 2-1 through 2-n (hereinafter generically referred to as the network device 2-i), the GUI control section 44 accepts this operation via the Web browser 48.

Further, the GUI control section 44 acquires from the template DB 46 a template to be used for displaying the setting of the ports 26-1 through 26-m (FIG. 2; FIG. 14) of the selected network device 2-i (1 ? I ? n), and the setting and status of the network device 2-i, and supplies it to the Web browser 48.

The Web browser 48, using this template, displays a third GUI picture 56, an example of which is shown in FIG. 14, on the display/input unit 180 (FIG. 3).

Incidentally, a template different from the template 50 shown in FIG. 5 is illustrated in FIG. 14, and this is an example wherein m=6 is supposed.

As shown in FIG. 12, at step 140 (S140), the GUI control section 44 determines whether or not any of the icons (#1 through #6) displayed in the port display section 524 of the third GUI picture 56 (FIG. 14), and representing the ports 26-1 through 26-6, has been selected.

If any of the icons (#1 through #6) representing the ports 26-1 through 26-6 has been selected, the network management program 4 goes ahead to processing of S142, or otherwise goes ahead to processing of S144.

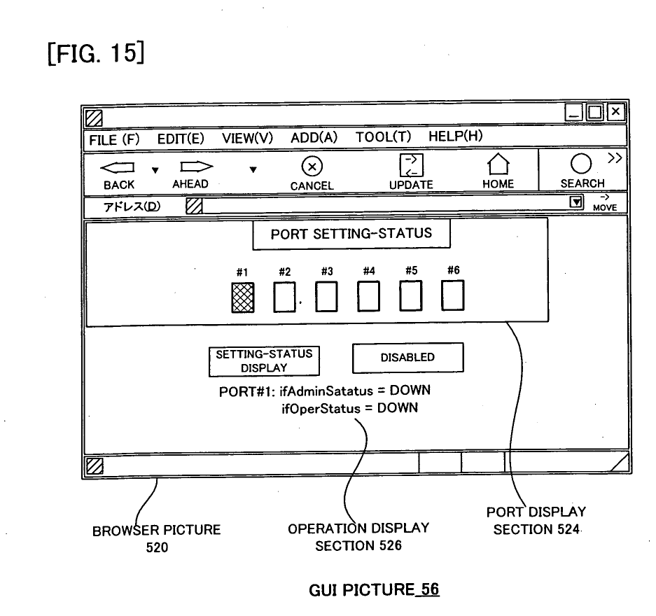

FIG. 15 is a first diagram showing an example of variation of the third GUI picture 56 shown in FIG. 14.

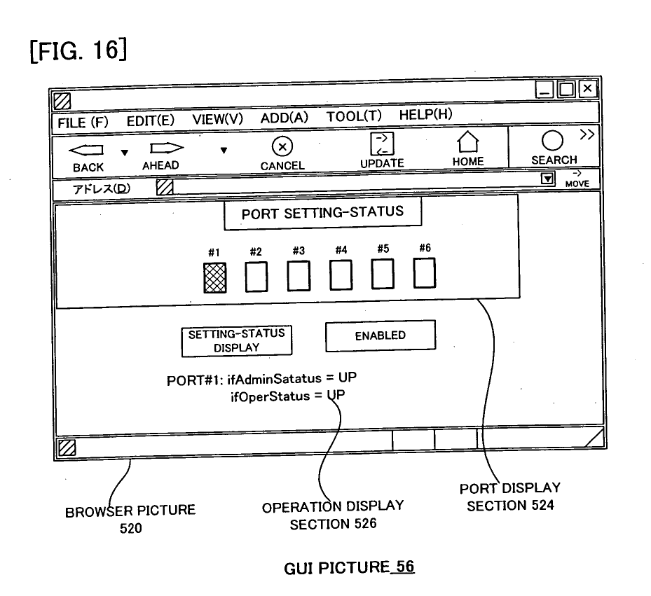

FIG. 16 is a second diagram showing an example of variation of the third GUI picture 56 shown in FIG. 14.

At step 142 (S142), the GUI control section 44 alters the color, brightness or shape of the icon representing the selected port 26-j (an example of j=1 in FIG. 15) in the port display section 524 as shown in FIG. 15 and FIG. 16.

At step 144 (S144), the GUI control section 44 determines, for instance, whether or not any operation has been made on an icon (setting-status display) displayed in the operation display section 526 of the GUI picture 56 shown in FIG. 15, to display the setting and status of the port 26-j (if no port 26-j has been selected, every one of the ports 26-1 through 26-m) of the network device 2-i.

If any operation on the icon (setting-status display) has been made, the GUI control section 44 supplies this operation to the network unit management section 42, and the network management program 4 goes ahead to processing of S146.

In any other case, the network management program 4 goes ahead to processing of S148.

At step 146 (S146), the network unit management section 42, in response to the operation entered via the GUI control section 44, requests unit information on the port 26-j (if no port 26-j has been selected, every one of the ports 26-1 through 26-m) from the network device 2-i.

At step 148 (S148), the GUI control section 44 determines, for instance, whether or not any operation has been made on an icon (disable) displayed in the operation display section 526 of the GUI picture 56 shown in FIG. 15 to alter the setting for the port 26-j (if no port 26-j has been selected, every one of the ports 26-1 through 26-m) of the network device 2-i.

If any operation on this icon (disable) has been made, the GUI control section 44 supplies this operation to the network unit management section 42, and the network management program 4 goes ahead to processing of S152.

In any other case, the network management program 4 goes ahead to processing of S150.

At step 150 (S150), the network management program 4 meets other processing requirements.

At step 152 (S152), the network unit management section 42 requests the network device 2-i to alter the setting of the port 26-j (if no port 26-j has been selected, every one of the ports 26-1 through 26-m) of the network device 2-i.

At step 154 (S154), the network unit management section 42 determines whether or not any response has been received from the network device 2-i.

If any response has been received, the network management program 4 goes ahead to processing of S160, or otherwise goes ahead to processing of S156.

At step 156 (S156), the network unit management section 42, after making a request to the network device 2-i, determines whether or not a certain length of time has passed.

If that length of time has passed, the network management program 4 returns to processing of S154, or otherwise goes ahead to processing of S158.

At step 158 (S158), the network unit management section 42 performs exception processing such as displaying an error message on the display/input unit 180, via the GUI control section 44 and the Web browser 48.

At step 160 (S160), the network unit management section 42 supplies the GUI control section 44 with the response received from the network device 2-i.

The GUI control section 44 alters the contents of the third GUI picture 56 according to the response received from the network unit management section 42.

If, for instance, the user has made an operation to cause the setting and status of the port 26-j of the network device 2-i to be displayed, the GUI control section 44 displays, according to the response, the setting and status (PORT#1: if AdminStatus=DOWN/UP, if OperStatus=DOWN/UP) of the port 26-j as shown in FIG. 15 and FIG. 16.

Alternatively, for instance, when the port 26-j of the network device 2-i is disabled (PORT#1: if AdminStatus DOWN), if the user makes an operation upon the third GUI picture 56 shown in FIG. 15 to alter the setting to enable this port 26-j(PORT#1: if AdminStatus=UP), the GUI control section 44 according to the response displays the altered setting of the port. 26-j and its status (PORT#1: if AdminStatus=UP, if OperStatus=UP) as shown in FIG. 16 when notified by the network device 2-i of the completion of that setting.

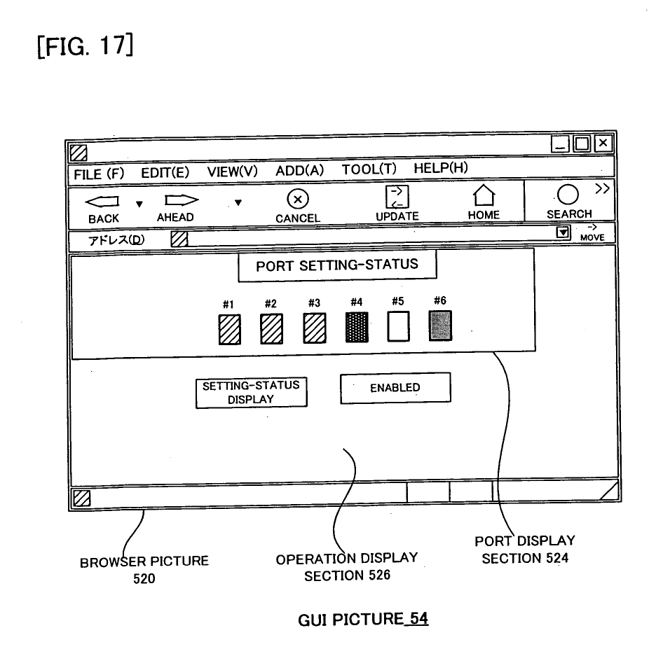

FIG. 17 is a third diagram showing an example of variation of the third GUI picture 56 shown in FIG. 14.

Alternatively, if no specific port 26-j is selected and yet an operation is done on an icon for displaying setting and status or an icon for a setting change, the color, brightness and shape of the icons (#1 through #6) respectively matching ports 26-1 through 26-6 may be altered to match this setting and status and the altered color, brightness and shape displayed as shown in FIG. 17.

[Overall Operation of Network System 1]

The overall operation of the network system 1 (FIG. 1) will be described below.

[Operation Regarding Template]

First will be described the operation of the network system 1 regarding the template.

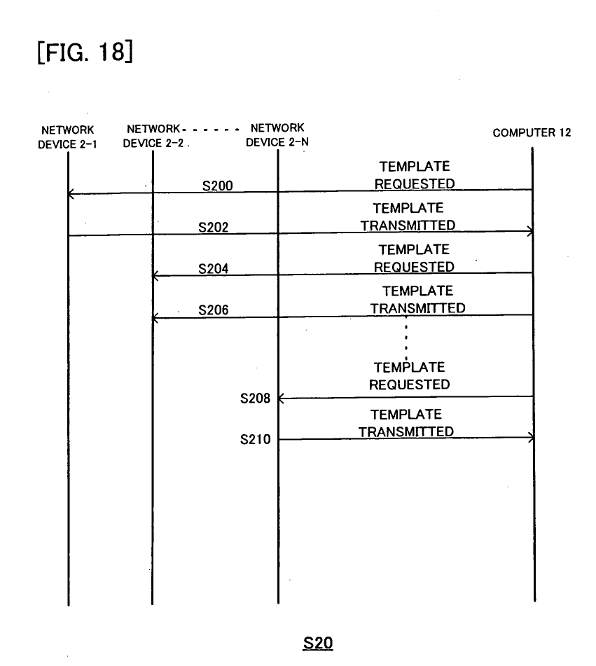

FIG. 18 is a sequence diagram showing a request for a template and the operation to transmit it (S20) in the network system 1.

For instance if the network system 1 is actuated for the first time, the network device program 3 (FIG. 8) is actuated on the computer 12 (FIG. 1 and FIG. 3), and the processing regarding the template (S12) shown in FIG. 11 is first performed.

Further, on the network devices 2-1 through 2-m (FIG. 1 and FIG. 2), the network device program 3 (FIG. 1) is actuated, and the processing shown in FIG. 7 (S10) is performed.

As shown in FIG. 18, the computer 12 (the network management program 4) requests a template (FIG. 5) from each of the network devices 2-1 through 2-m (S200, S204 and S208)

Each of the network devices 2-1 through 2-m (the network device program 3), responding to the request by the computer 12 (the network management program 4), transmits an SVG program (FIG. 6) or the like for drawing templates to the computer 12 (the network management program 4) (S202, S206 and S210).

[Operation After Template Acquisition]

Next will be described the operation that takes place after the computer 12 (the network management program 4) has acquired a template.

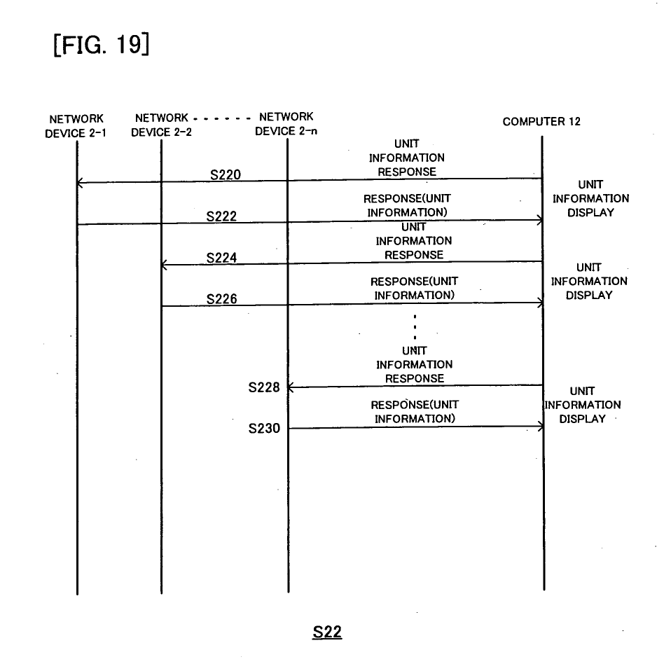

FIG. 19 is a sequence diagram showing a request for unit information and the operation to transmit it (S22) in the network system 1.

After the acquisition of a template, the processing shown in FIG. 12 (S14) is performed by the computer 12 (the network management program 4).

As shown in FIG. 19, the computer 12 (the network management program 4), in response to the operation by the user, requests unit information from each of the network devices 2-1 through 2-m (S220, S224 and S228).

Each of the network devices 2-1 through 2-m (the network device program 3) in response to the operation by the computer 12 (the network management program 4)., reads the setting and status of respective constituent parts (FIG. 3) of the network devices 2-1 through 2-m, and as a response transmits the unit information to the computer 12 (the network management program 4) (S222, S226 and S230).

Having received this unit information as a response, the computer 12 (the network management program 4) alters the contents of the third GUI picture 56 shown in FIG. 14 as shown in FIG. 15 through FIG. 17, and displays the altered unit information.

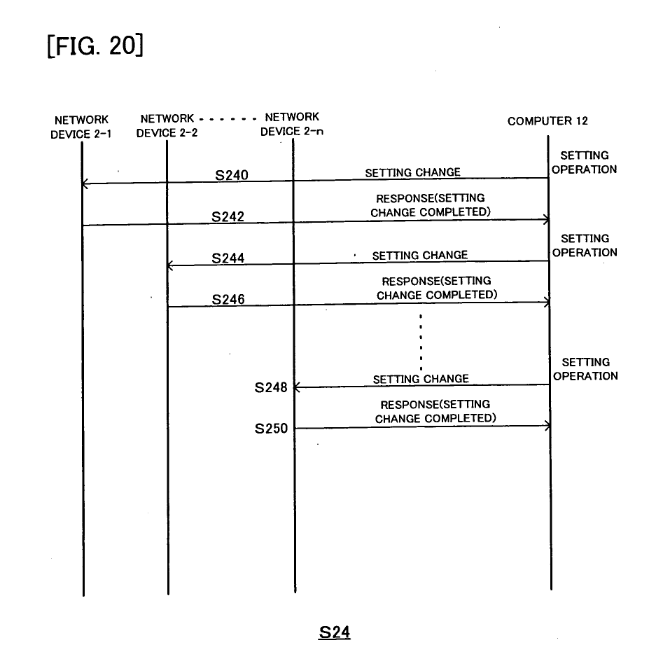

FIG. 20 is a sequence diagram showing a request for a setting change and a response thereto (S24) in the network system 1.

As shown in FIG. 20, the computer 12 (the network management program 0.4), in response to an operation by the user, requests each of the network devices 2-1 through 2-m to alter the settings for the constituent parts of the network devices 2-1 through 2-m (S240, S244 and S248).

Each of the network devices 2-1 through 2-m (the network device program 3), in response to the request by the computer 12 (the network management program 4), alters the settings for the constituent parts of the network devices 2-1 through 2-m(FIG. 3)

Upon completion of the setting change, each of the network devices 2-1 through 2-m transmits to the computer 12 (the network management program 4) a notice of completion of the setting change as a response (S242, S246 and S250).

Receiving this note of setting change completion, the computer 12 (the network management program 4) alters the contents of the third GUI picture 56 shown in FIG. 14 as shown in FIG. 15 through FIG. 17, and displays the setting completion, contents of the altered setting, and the setting and status of the constituent parts of each of the network devices 2-1 through 2-m.

As hitherto described, the unit management system and method according to the present invention, even if the communication nodes subject to unit management are great in number and variety, can perform unit management by use of the most suitable operational picture for each.

Also, the unit management system and method according to the invention not only permit management and operation by GUI upon a communication node, but also dispense with the need to prepare on the part of the management apparatus an operational picture for each communication node to undergo unit management.

The unit management system and method according to the present invention can be utilized for unit management of communication nodes and the like in networks.

What is claimed is:

1. An unit management system comprising one or more communication nodes and a management apparatus connected to the communication nodes to perform unit management of each of the communication nodes, wherein
each of the communication nodes has:
operational picture providing means for providing the management apparatus with picture data representing operational pictures for use in operations for the unit management of the communication node, and
unit management means for performing the unit management of the communication node under the control of the management apparatus, and
the management apparatus has:
operational picture display means for displaying the operational pictures by use of picture data provided by each of the communication nodes, and
unit management means for controlling, in accordance with operations on the displayed operational pictures, the unit management of the communication node matching the operational pictures operated upon.

2. A communication node controlled by a management apparatus, which displays operational pictures provided by the communication node and performs control for the unit management in accordance with operations on the displayed operational pictures, the communication node having;
operational picture providing means for providing the management apparatus with picture data representing the operational pictures for use in operations for the unit management, and
unit management means for performing the unit management under the control of the management apparatus.

3. The communication node according to claim 2, wherein
the communication node has one or more ports for communication, and
the operational picture providing means provide the management apparatus with picture data representing operational pictures including one or more port pictures respectively representing the one or more ports.

4. The communication node according to claim 2 or 3, wherein the operational picture providing means provide the management apparatus with, as the picture data, a picture drawing program for displaying the operational pictures.

5. A management apparatus connected to one or more communication nodes to perform unit management of each of the communication nodes, wherein
each of the communication nodes provides the management apparatus with picture data representing operational pictures for use in operations for the unit management of the communication node, and performs the unit management of the communication node under the control of the management apparatus,
operational picture display means for displaying the operational pictures by use of picture data provided by each of the communication nodes, and
unit management means for controlling, in accordance with operations on the displayed operational pictures, the unit management of the communication node matching the operational pictures operated upon.

6. The management apparatus according to claim 5, wherein
each of the communication nodes provides, as the picture data, a picture drawing program for displaying the operational pictures, and
the operational picture display means execute the picture drawing program provided by each of the communication nodes to display the operational pictures.

7. The management apparatus according to claim 5 or 6, wherein
each of the communication nodes returns, in response to control by the management apparatus, unit information indicating a status and a setting or either of them of the communication node to the management apparatus, and
the operational picture display means alter contents of the displayed operational pictures on the basis of the unit information from the communication node.

8. The management apparatus according to claim 7, wherein
each of the communication nodes has one or more ports for communication, and provides the management apparatus with picture data representing operational pictures including one or more port pictures respectively representing the one or more ports,
the operational picture display means display operational pictures including the one or more port pictures by use of picture data provided by each of the communication nodes, and
the unit management means, in accordance with operations on the one or more port pictures included in the displayed operational pictures, control the communication node matching the operational pictures operated upon to perform unit management of the ports respectively matching the port pictures operated upon.

9. The management apparatus according to claim 7 or 8, wherein the operational picture display means, in response to operations on each of the one or more port pictures, alter display of each of the port pictures having undergone the operation.

10. An unit management method for communication nodes managed by a management apparatus, wherein the management apparatus displays operational pictures provided by the communication nodes, performs control for unit management in accordance with operations on the displayed operational pictures,
provides the management apparatus with picture data representing operational pictures for use in operations for the unit management, and
performs the unit management in accordance with control by the management apparatus.

11. An management apparatus method to be performed by a management apparatus, connected to one or more communication nodes, for performing unit management of each of the communication nodes, wherein each of the communication nodes provides the management apparatus with picture data representing operational pictures for use in operations for the unit management of the communication node, performs the unit management of the communication node in accordance with control by the management apparatus,
displays the operational pictures by use of picture data provided by each of the communication nodes, and
performs, in accordance with operations on the displayed operational pictures, the unit management of the communication node matching the operational pictures operated upon.

12. A program to be executed by communication nodes each including a computer and managed by a management apparatus, wherein the management apparatus displays operational pictures provided by the communication nodes and performs control for unit management in accordance with operations on the displayed operational picture,
the program causing the computer to execute:
a step of providing the management apparatus with picture data representing operational pictures for use in operations for the unit management, and
a step of performing the unit management in accordance with control by the management apparatus.

13. A program to be executed by a management apparatus, including a computer and connected to one or more communication nodes, to perform unit management of each of the communication nodes, wherein each of the communication node provides the management apparatus with picture data representing operational pictures for use in operations in the unit management of the communication node and, in accordance with control by the management apparatus, performs the unit management of the communication node,
the program causing the computer to execute:
a step of displaying the operational pictures by use of picture data provided by each of the communication nodes, and
a step of performing control for the unit management, in accordance with operations on the displayed operational pictures, of the communication node matching the operational pictures operated upon.
